(19) United States
(12) Patent Application Publication
(10) Pub. No.: US 2007/0049377 A1
(43) Pub. Date: Mar. 1, 2007

(54) Greasable CV-joint wheel hub

(75) Inventor: Larry Keith Ayers, Peoria, AZ (US)

Correspondence Address: MESCHKOW & GRESHAM, P.L.C., 5727 NORTH SEVENTH STREET, SUITE 409, PHOENIX, AZ, 85014, US

(73) Assignee: Ayers Gear and Machine, Inc.

(21) Appl. No.: 11/211,998

(22) Filed: Aug. 24, 2005

(51) Int. Cl. F16C 1/24

(52) U.S. Cl. 464/7

(57) ABSTRACT

A greasable wheel hub (20) using a constant-velocity (CV) joint (22) as a hub spindle is taught. The wheel hub (20) includes a hub cover (28) attached to a hub body (24), which in turn is attached to a CV housing (32) and a CV bearing (34), both of which are portions of the CV joint (22). A grease (146) is injected through a grease fitting (136) into a grease trough (142) at the interface between the hub cover (28) and the hub body (24). This grease (146) is then conveyed through a plurality of grease passages (144) to the CV housing (32), where it provides lubrication for the CV joint (22). Another grease (246) is injected through another grease fitting (236) into another grease trough (242). This grease (246) is then conveyed though a plurality of other grease passages (244) and a plurality of grease channels (248) to the CV bearing (34), where it provides lubrication.

### TECHNICAL FIELD OF THE INVENTION

The present invention relates to the field of wheel hubs. More specifically, the present invention relates to the field of motor-vehicle wheel hubs utilizing constant-velocity joints as spindles.

### BACKGROUND OF THE INVENTION

It is common to use constant-velocity (CV) joints as spindles for motor vehicle wheels. The use of CV joints allow the transfer of energy through an angular connection. This allows for the use of wheels with independent suspension, and significantly increases the ability of the wheel to maintain contact with the surface over which the vehicle is travelling.

These becomes especially important when the surface is irregular, and/or the vehicle is maintaining a high rate of speed for that surface. In activities such as off-road racing, where the terrain in rough and the relative speed is high, Good suspension becomes critical. This virtually mandates the use of independent suspension and CV joints on all four wheels.

One primary problem exists with conventional CV joints: that of lubrication. The inherent structure of the conventional CV joint makes lubrication difficult. With conventional CV joints, lubrication requires disassembly. In a race, this is not practical. The conventional approach is therefore to replace the wheel hub, with its CV joint, in the field.

Hub replacement is time consuming. In a race, even a short time encompassed in a pit stop can mean the difference between winning and losing. Therefore, any methodology that decreases the pit-stop time is highly desirable.

### SUMMARY OF THE INVENTION

Accordingly, it is an advantage of the present invention that a greasable CV-joint wheel hub is provided.

It is another advantage of the present invention that a greasable wheel hub is provided that allows the CV joint acting as a spindle therein to be lubricated without disassembly.

It is another advantage of the present invention that a greasable wheel hub is provided that allows both the CV joint itself and it's primary bearing to be lubricated in the field without dismounting the hub.

The above and other advantages of the present invention are carried out in one form by a wheel hub for a motor vehicle using a CV joint as a hub spindle. The wheel hub incorporates a CV housing realized as a portion of the said CV joint, a hub body configured to mate with the CV housing, and a hub cover, where an inner face of the hub cover is configured to mate with an outer face of the hub body. A grease fitting is coupled into a fitting socket formed onto an outer face of the hub cover. A grease trough coupled to the fitting socket is formed onto either the inner face of the hub cover or the outer face of the hub body. A grease passage is formed through the hub body so as to extend from the grease trough to the CV housing. The grease fitting is configured to permit the injection of a grease into the grease trough, and the grease passage is configured to convey the grease from the grease trough to the CV joint.

The above and other advantages of the present invention are carried out in another form by a wheel hub for a motor vehicle using a CV joint as a hub spindle. The wheel hub includes a CV bearing coupled to a CV housing, where both the CV bearing and the CV housing are portions of the CV joint, a hub body configured to mate with the CV housing, and a hub cover having an inner face configured to mate with an outer face of the hub body. A grease fitting is coupled into a fitting socket formed onto an outer face of the hub cover. A grease trough coupled to the fitting socket is formed onto either the inner face of the hub cover or the outer face of the hub body. A grease passage is formed through the hub body so as to extend from the grease trough to the CV housing. A grease channel is formed in an outer surface of the CV housing and configured to extend from the grease passage to the CV bearing. The grease fitting is configured to permit the injection of a grease into the grease trough, the grease passage is configured to convey the grease from the grease trough to the CV housing, and the grease channel is configured to convey the grease from the grease passage to the CV bearing.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view depicting a wheel hub in accordance with a preferred embodiment of the present invention;

FIG. 2 shows an end view depicting the wheel hub of FIG. 1 in accordance with a preferred embodiment of the present invention;

FIG. 3 shows a first cross-sectional side view depicting a portion of the wheel hub of FIGS. 1 and 2 in accordance with a preferred embodiment of the present invention; and

FIG. 4 shows a second cross-sectional side view depicting a portion of the wheel hub of FIGS. 1 and 2 in accordance with a preferred embodiment of the present invention.

### DETAILED DESCRIPTION OF THE PREFERRED EMBODIMENTS

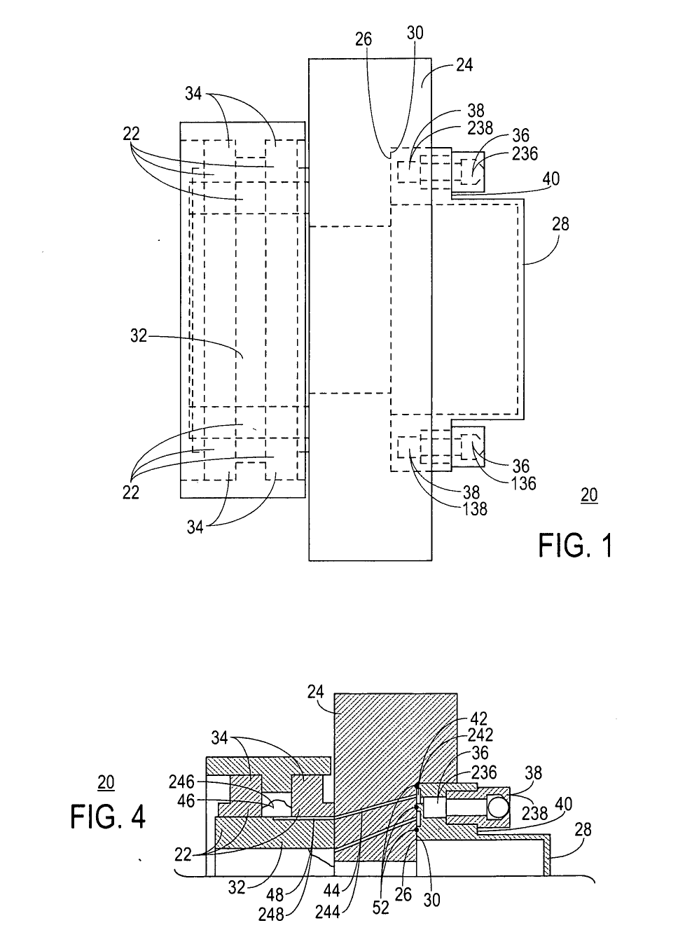

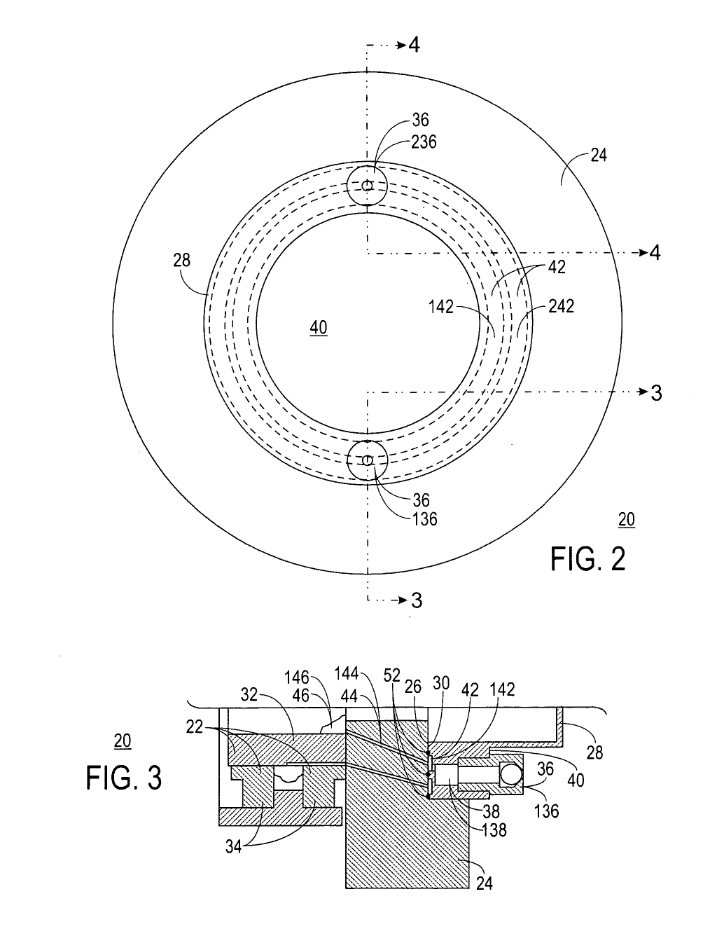

FIGS. 1 and 2 show side and end views, respectively, of a wheel hub 20 for a motor vehicle in accordance with a preferred embodiment of the present invention. FIGS. 2 and 3 show first and second cross-sectional side views of wheel hub 20 in accordance with a preferred embodiment of the present invention. The following discussion refers to FIGS. 1 through 4.

Wheel hub 20 is a motor vehicle wheel hub utilizing a constant-velocity (CV) joint 22 as a hub spindle. CV joint 22 is not shown in the Figures in its entirety. Rather, only portions of CV joint 22 relevant to this discussion are shown.

Wheel hub 20 is a greasable wheel hub. That is, wheel hub 20 contains provisions for greasing CV joint 22 without the disassembly of wheel hub 20, and without the removal of wheel hub 20 from the motor vehicle (not shown).

In construction, wheel hub 20 is made up of a hub body 24, to which other components of wheel hub 20 are attached. Hub body 24 may include or have attached thereto other components not relevant to this discussion and not depicted in the Figures, such as brake disks, etc. Those skilled in the art will appreciate that the inclusion of such other components does not depart from the spirit of the present invention.

Hub body 24 has an outer face 26. A hub cover 28 is attached to hub body 24. Hub cover 28 has an inner face 30. Outer face 26 of hub body 24 and inner face 30 of hub cover 28 are configured to mate together to provide a conventional contaminate barrier for wheel hub 20.

Hub body 24, is configured to mate with a CV housing 32. coupled to CV housing 32 is a CV bearing 34. CV housing 32 and CV bearing 34 are realized as portions of CV joint 22. That is. CV joint 22 includes CV housing 32 and CV bearing 34, along with other components not depicted nor discussed herein.

It is a primary purpose of wheel hub 20 to allow for the lubrication of CV joint 22 without the disassembly or dismounting of wheel hub 20. The lubrication of CV joint 22 is in two forms: the lubrication of CV joint 22 proper; and the lubrication of CV bearing 34. These lubrications and all components associated therewith are hereinafter referred to as “J” lubrication and components for CV joint 22 proper, and “B” lubrication and components for CV bearing 34 lubrication. To further differentiate the components for the two lubrications, components that are “generic” (i.e., apply to either lubrication) have two-digit reference numbers, components for “J” lubrication have three-digit reference numbers in the range of 100-199, and components for “B” lubrication have three digit reference numbers in the range 200-299, where all like components have the same two least-significant digits, e.g., grease 46, “J” grease 146, and “B” grease 246.

The following discussion refers to FIGS. 1, 2 and 3, and discusses “J” lubrication.

A grease fitting 36 is coupled to a fitting socket 38 formed on an outer face 40 of hub cover. These are “J” grease fitting 136 and “J” fitting socket 138. At the interface between hub cover 28 and hub body 24 is a grease trough 42 (shown as an inner grease trough 42 in FIG. 2), i.e., “J” grease trough 142. “J” grease trough 142 is configured to communicate with (i.e., receive grease from) “J” fitting socket 138.

“J” grease trough 142 is formed at the interface between hub cover 28 and hub body 24. In the embodiment of FIG. 3, “J” grease trough 142 is formed as a groove within inner face 30 of hub cover 28. Those skilled in the art will appreciate that this is not a requirement of the present invention. “J” grease trough 142 may be formed in an alternative manner, e.g., as either a groove or protrusions on either inner face 30 of hub cover 28 or outer face 26 of hub body 24, without departing from the spirit of the present invention.

At least one grease passage 44, “J” grease passage 144, is formed through hub body 24. “J” grease passage 144 extends from “J” grease trough 142 to CV housing 32.

During “J” lubrication, a grease 46 suitable for the lubrication of CV joint 22, i.e., a “J” grease 146, is injected into “J” grease fitting 136, and thence through “J” socket 138 and into “J” grease trough 142. “J” grease 146 is then conveyed by “J” grease passage 144 from “J” grease trough 142, through hub body 24, and to CV Housing 32, where it is then able to lubricate CV joint 22.

The following discussion refers to FIGS. 1, 2 and 4, and discusses “B” lubrication.

Another grease fitting 36 is coupled to another fitting socket 38 formed on outer face 40 of hub cover. These are “B” grease fitting 236 and “B” fitting socket 238. At the interface between hub cover 28 and hub body 24 is another grease trough 42 (shown as an outer grease trough 42 in FIG. 2), i.e., “B” grease trough 242. “B” grease trough 242 is configured to communicate with (i.e., receive grease from) “B” fitting socket 238.

“B” grease trough 242 is formed at the interface between hub cover 28 and hub body 24. In the embodiment of FIG. 4, “B” grease trough 242 is formed as a groove within inner face 30 of hub cover 28. Those skilled in the art will appreciate that this is not a requirement of the present invention. “B” grease trough 142 may be formed in an alternative manner, e.g., as either a groove or protrusions on either inner face 30 of hub cover 28 or outer face 26 of hub body 24, without departing from the spirit of the present invention.

At least one grease passage 44, “B” grease passage 244, is formed through hub body 24. “B” grease passage 244 extends through hub body 24 from “B” grease trough 242 to CV housing 32.

At least one grease channel 48, “B” grease channel 248, is formed along an outer surface 50 of CV housing 32. “B” grease channel 248 extends along CV housing 32 from “B” grease passage 244 to CV bearing 34.

During “B” lubrication, another grease 46 suitable for the lubrication of CV bearing 34, i.e., a “B” grease 246, is injected into “B” grease fitting 236, and thence through “B” socket 238 and into “B” grease trough 242. “B” grease 246 is conveyed by “B” grease passage 244 from “B” grease trough 242, through hub body 24, and to CV Housing 32, then is conveyed by “B” grease channel 248 from “B” grease passage 244, along outer surface 50 of CV housing 32, and to CV bearing 34, where it is then able to lubricate CV bearing 34.

The following discussion refers to FIGS. 1 through 4.

Grease passages 44 and grease channels 48 are desirably plural. In the preferred embodiment, there are six “J” grease passages 144, and six “B” grease passages 244 with six associated grease channels 248, with each “B” grease passage 244 connecting up with one corresponding “B” grease channel 248. Two “J” grease passages 144, two “B” grease passages 244, and two “B” grease channels 148 are shown in the combination of FIGS. 3 and 4. Those skilled in the art will appreciate that the exact number of grease passages 44 and grease channels 48 is not a requirement of the present invention. Differing numbers of each may be incorporated without departing from the spirit of the present invention.

Grease passages 144 are desirably substantially identical, i.e., pass through hub body 24 in substantially identical manners. Similarly, Grease passages 244 are desirably identical, and grease channels 248 are desirably identical. Those skilled in the art will appreciate, however, that this is not a requirement of the present invention. Substantial variations in the routing and dimensions of grease passages 144, grease passages 244, and grease channels 248 may be realized without departing from the spirit of the present invention.

Grease 46 would tend to migrate out of grease troughs 42. In the preferred embodiment, O-rings 52 are used surrounding and between grease troughs 42. In this manner, O-rings 52 maintain “J” grease 146 in “J” grease trough 142 and “B” grease 246 in “B” grease trough 242. In this embodiment, O-rings 52 are fitted under pressure into small grooves (not shown) in outer face 26 of hub body 24 and inner face 30 of hub cover 28. Those skilled in the art will appreciate that this is not a requirement of the present invention. Other methods of securing O-rings 52 may be used without departing from the spirit of the present invention.

In summary, the present invention teaches a greasable CV-joint wheel hub 20. Wheel hub 20 allows a CV joint 22 acting as a hub spindle to be lubricated without disassembly. Wheel hub 20 also allows both the CV joint 22 itself and it's primary CV bearing 34 to be lubricated in the field without dismounting the hub.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A wheel hub for a motor vehicle, said wheel hub using a constant-velocity (CV) joint as a hub spindle, and said wheel hub comprising:
a CV housing realized as a portion of said CV joint;
a hub body configured to mate with said CV housing and having an outer face;
a hub cover having an inner face configured to mate with said outer face of said hub body and having an outer face;
a fitting socket formed onto said outer face of said hub cover;
a grease trough coupled to said fitting socket and formed onto one of said inner face of said hub cover and said outer face of said hub body;
a grease passage formed through said hub body so as to extend from said grease trough to said CV housing;
a grease fitting coupled to said fitting socket; and
wherein:
said grease fitting is configured to permit the injection of a grease into said grease trough; and
said grease passage is configured to convey said grease from said grease trough to said CV joint.

2. A wheel hub as claimed in claim 1 wherein:
said grease passage is one of a plurality of grease passages;
each of said grease passages is formed through said hub body so as to extend from said grease trough to said CV housing; and
each of said grease passages is configured to convey said grease from said grease trough to said CV joint.

3. A wheel hub as claimed in claim 1 additionally comprising an O-ring configured to maintain said grease within said grease trough.

4. A wheel hub as claimed in claim 1 wherein:
said grease is a first grease;
said grease fitting is a first grease fitting;
said fitting socket is a first fitting socket;
said grease trough is a first grease trough;
said grease passage is a first grease passage;
said wheel hub additionally comprises:
a CV bearing realized as a portion of said CV joint and coupled to said CV housing;
a second fitting socket formed onto said outer face of said hub cover;
a second grease trough coupled to said second fitting socket and formed onto one of said inner face of said hub cover and said outer face of said hub body;
a second grease passage formed through said hub body so as to extend from said second grease trough to said CV housing;
a grease channel formed along an outer surface of said CV housing so as to extend from said second grease passage to said CV bearing; and
a second grease fitting coupled to said second fitting socket;
said second grease fitting is configured to permit the injection of a second grease into said second grease trough;
said second grease passage is configured to convey said second grease from said second grease trough to said grease channel; and
said grease channel is configured to convey said second grease from said second grease passage to said CV bearing.

5. A wheel hub as claimed in claim 4 wherein:
said second grease passage is one of a plurality of second grease passages;
each of said second grease passages is formed through said hub body so as to extend from said second grease trough to said CV housing;
said grease channel is one of a plurality of grease channels;
each of said grease channels is formed along an outer surface of said CV housing so as to extend from one of said second grease passages to said CV bearing;
each of said second grease passages is configured to convey said second grease from said second grease trough to one of said grease channels; and
each of said grease channels is configured to convey said second grease from one of said second grease passages to said CV bearing.

6. A wheel hub as claimed in claim 4 wherein:
said first grease passage is one of a plurality of substantially identical first grease passages;
said second grease passage is one of a plurality of substantially identical second grease passages; and
said grease channel is one of a plurality of substantially identical grease channels.

7. A wheel hub as claimed in claim 4 additionally comprising a plurality of O-rings, wherein each of said O-rings is configured to maintain one of said first and second greases in one of said first and second grease troughs, respectively.

8. A wheel hub as claimed in claim 4 wherein:
said second grease trough is substantially coincident with said first grease trough; and
said second grease is substantially identical to said first grease.

9. A wheel hub for a motor vehicle, said wheel hub using a constant-velocity (CV) joint as a hub spindle and said wheel hub comprising:
a CV bearing realized as a portion of said CV joint;
a CV housing realized as a portion of said CV joint, coupled to said CV bearing, and having an outer surface;
a hub body configured to mate with said CV housing and having an outer face;
a hub cover having an inner face configured to mate with said outer face of said hub body and having an outer face;
a fitting socket formed onto said outer face of said hub cover;
a grease trough coupled to said fitting socket and formed onto one of said inner face of said hub cover and said outer face of said hub body;
a grease passage formed through said hub body and configured to extend from said grease trough to said CV housing;
a grease channel formed in said outer surface of said CV housing and configured to extend from said grease passage to said CV bearing;
a grease fitting coupled to said fitting socket; and
wherein:
said grease fitting is configured to permit the injection of a grease into said grease trough;
said grease passage is configured to convey said grease from said grease trough to said grease channel; and
said grease channel is configured to convey said grease from said grease passage to said CV bearing.

10. A wheel hub as claimed in claim 9 wherein:
said grease is a first grease;
said grease fitting is a first grease fitting;
said fitting socket is a first fitting socket;
said grease trough is a first grease trough;
said grease passage is a first grease passage;
said wheel hub additionally comprises:
a second fitting socket formed onto said outer face of said hub cover;
a second grease trough coupled to said second fitting socket and formed onto one of said inner face of said hub cover and said outer face of said hub body;
a second grease passage formed through said hub body so as to extend from said second grease trough to said CV housing;
a second grease fitting coupled to said second fitting socket;
said second grease fitting is configured to permit the injection of a second grease into said second grease trough; and
said second grease passage is configured to convey said second grease from said second grease trough to said CV joint.

11. A wheel hub as claimed in claim 10 wherein:
said first grease passage is one of a plurality of first grease passages;
said grease channel is one of a plurality of grease channels.

12. A wheel hub as claimed in claim 11 wherein:
each of said first grease passages is configured to convey said first grease from said first grease trough to one of said grease channels; and
each of said grease channels is configured to convey said first grease from one of said first grease passages to said CV bearing.

13. A wheel hub as claimed in claim 10 wherein said second grease passage is one of a plurality of second grease passages.

14. A wheel hub as claimed in claim 13 wherein each of said second grease passages is configured to convey said second grease from said second grease trough to said CV joint.

15. A wheel hub as claimed in claim 10 additionally comprising a plurality of O-rings, wherein each of said O-rings is configured to maintain one of said first and second greases in one of said first and second grease troughs, respectively.

16. A wheel hub for a motor vehicle, said wheel hub using a constant-velocity (CV) joint as a hub spindle and said wheel hub comprising:
a CV bearing realized as a portion of said CV joint;
a CV housing realized as a portion of said CV joint, coupled to said CV bearing, and having an outer surface;
a hub body configured to mate with said CV housing and having an outer face;
a hub cover having an inner face configured to mate with said outer face of said hub body and having an outer face;
a first fitting socket formed onto said outer face of said hub cover;
a first grease trough coupled to said first fitting socket and formed onto one of said inner face of said hub cover and said outer face of said hub body;
a first grease passage formed through said hub body so as to extend from said first grease trough to said CV housing;
a first grease fitting coupled to said first fitting socket;
a second fitting socket formed onto said outer face of said hub cover;
a second grease trough coupled to said second fitting socket and formed onto one of said inner face of said hub cover and said outer face of said hub body;
a second grease passage formed through said hub body and configured to extend from said second grease trough to said CV housing;
a grease channel formed in said outer surface of said CV housing and configured to extend from said second grease passage to said CV bearing;
a second grease fitting coupled to said second fitting socket; and
wherein:
said first grease fitting is configured to permit the injection of a first grease into said first grease trough;
said first grease passage is configured to convey said first grease from said first grease trough to said CV joint;
said second grease fitting is configured to permit the injection of a second grease into said second grease trough;
said second grease passage is configured to convey said second grease from said second grease trough to said grease channel; and
said grease channel is configured to convey said second grease from said second grease passage to said CV bearing.

17. A wheel hub as claimed in claim 16 wherein:
said first grease passage is one of a plurality of first grease passages;
each of said first grease passages is formed through said hub body so as to extend from said first grease trough to said CV housing; and
each of said first grease passages is configured to convey said first grease from said first grease trough to said CV joint.

18. A wheel hub as claimed in claim 17 wherein:
said second grease passage is one of a plurality of second grease passages;
said grease channel is one of a plurality of grease channels;
each of said second grease passages is formed through said hub body and configured to extend from said second grease trough to said CV housing;
each of said grease channels is formed in said outer surface of said CV housing and configured to extend from said second grease passage to said CV bearing;
each of said second grease passages is configured to convey said second grease from said second grease trough to one of said grease channels; and
each of said grease channels is configured to convey said second grease from one of said second grease passages to said CV bearing.

19. A wheel hub as claimed in claim 16 additionally comprising a plurality of O-rings, wherein:
one of said O-rings is configured to maintain said first grease within said first grease trough; and
one of said O-rings is configured to maintain said second grease within said second grease trough.
